(19) United States
(12) Patent Application Publication
(10) Pub. No.: US 2014/0352292 A1
(43) Pub. Date: Dec. 4, 2014

(54) MOTION MACHINE

(71) Applicant: John Gahan, Warracknabeal (AU)

(72) Inventor: John Gahan, Warracknabeal (AU)

(21) Appl. No.: 14/344,168

(22) PCT Filed: Jun. 7, 2012
(86) PCT No.: PCT/AU2012/000654

§ 371 Date: Mar. 11, 2014

(30) Foreign Application Priority Data
Sep. 19, 2011 (AU) 2011903837

(51) Int. Cl. F03B 13/10

(52) U.S. Cl. CPC F03B 13/10
USPC 60/495

(57) ABSTRACT

A machine comprises a tank defining a liquid chamber for holding a liquid. A rotor is located in the liquid chamber and is mounted such that the rotor is able to rotate relative to the tank. The rotor comprises a plurality of positively buoyant first elements and a plurality of negatively buoyant second elements. The liquid chamber is able to hold the liquid so that the rotor is immersed in the liquid and the first and second elements are arranged so that the positive buoyancy of the first elements and the negative buoyancy of the second elements are able to cause the rotor to rotate.

### FIELD OF THE INVENTION

The present invention relates generally to machines, methods of rotating machine rotors, methods of controlling the rotational speed of machine rotors, and electricity generators.

Although the present invention will be described with particular reference to electricity generation, it will be appreciated that it is not necessarily limited to being employed in this manner.

### BACKGROUND ART

Electricity generators convert mechanical energy into electrical energy. The source of mechanical energy may be a reciprocating or turbine steam engine, water falling through a turbine or waterwheel, an internal combustion engine, a wind turbine, a hand crank, compressed air, or any other source of mechanical energy.

The two main parts of an electricity generator are the armature and the field. The armature is the electrical power-producing component of an electricity generator. The field of an electricity generator is the magnetic field component which interacts with the armature to generate electricity.

It would be desirable to have an alternative source of mechanical energy which may be used to drive an electricity generator.

It would also be desirable to have an alternative type of electricity generator.

It is against this background that the present invention has been developed.

### SUMMARY OF THE INVENTION

It is an object of the present invention to overcome, or at least ameliorate one or more of the deficiencies of the prior art mentioned above, or to provide the consumer with a useful or commercial choice.

Other objects and advantages of the present invention will become apparent from the following description, taken in connection with the accompanying drawings, wherein, by way of illustration and example, a preferred embodiment of the present invention is disclosed.

According to a first broad aspect of the present invention, there is provided a machine comprising a tank defining a liquid chamber for holding a liquid, and a rotor which is located in the liquid chamber and which is mounted such that the rotor is able to rotate relative to the tank, the rotor comprising a plurality of positively buoyant first elements and a plurality of negatively buoyant second elements, wherein the liquid chamber is able to hold the liquid so that the rotor is immersed in the liquid and the first and second elements are arranged so that the positive buoyancy of the first elements and the negative buoyancy of the second elements are able to cause the rotor to rotate.

Preferably, the rotor extends through a side wall of the tank so that a portion of the rotor is located inside the liquid chamber and so that another portion of the rotor is located outside the liquid chamber.

Preferably, the tank also defines an air chamber for holding air, and the portion of the rotor which is located outside the liquid chamber is located in the air chamber.

Preferably, the rotor comprises a toroid wheel formed by securing together the positively buoyant first elements and negatively buoyant second elements, and the tank also comprises a plurality of bearings for supporting a perimeter of the toroid wheel.

Preferably, the positively buoyant first elements comprise tubes.

Preferably, the negatively buoyant second elements comprise magnets.

Preferably, a plurality of holes extend through each magnet. Alternatively, each magnet includes a waisted section.

Preferably, the tank also comprises a release valve for draining the liquid from the liquid chamber, and a refill valve for refilling the tank with liquid, and the machine also comprises a speed sensor for monitoring the rotational speed of the rotor, an electronic circuit, and a fluid level sensing device for sensing the level of the liquid in the tank, wherein the electronic circuit and the fluid level sensing device are operable to cause the release valve to open to drain some of the liquid from the liquid chamber if the rotational speed of the rotor is faster than a desired rotational speed, and are operable to cause the refill valve to open to allow some liquid to flow into the liquid chamber if the rotational speed of the rotor is slower than a desired rotational speed.

Preferably, the tank also comprises an overflow valve for draining liquid from the air chamber that has leaked into that chamber from the liquid chamber.

Preferably, the machine also comprises an armature wound around the toroid wheel so that rotation of the rotor is able to cause a voltage to be generated across the armature.

According to a second broad aspect of the present invention, there is provided a method of rotating the rotor of the machine according to the first broad aspect of the present invention, the method comprising the steps of:

filling the liquid chamber of the tank with a liquid so that the rotor is immersed in the liquid; and

allowing the positive buoyancy of the first elements and the negative buoyancy of the second elements to cause the rotor to rotate.

According to a third broad aspect of the present invention, there is provided a method of controlling the speed of rotation of the rotor of the machine according to the first broad aspect of the present invention, the method comprising the steps of:

lowering the height of the liquid in the liquid chamber relative to the rotor so as to decrease the speed of rotation of the rotor; and

raising the height of the liquid in the liquid chamber relative to the rotor so as to increase the speed of rotation of the rotor.

According to a fourth broad aspect of the present invention, there is provided an electricity generator comprising the machine according to the first broad aspect of the present invention, a magnetic field source, and an armature, the rotor of the machine including one of the magnetic field source and the armature, and the other of the magnetic field source and the armature being positioned relative to the rotor such that rotation of the rotor is able cause a voltage to be generated across the armature.

According to a fifth broad aspect of the present invention, there is provided a perpetual motion machine comprising a tank defining a liquid chamber for holding a liquid, and a rotor which is located in the liquid chamber and which is mounted such that the rotor is able to rotate relative to the tank, the rotor comprising a plurality of positively buoyant first elements and a plurality of negatively buoyant second elements, wherein the liquid chamber is able to hold the liquid so that the rotor is immersed in the liquid and the first and second elements are arranged so that the positive buoyancy of the first elements and the negative buoyancy of the second elements are able to cause the rotor to rotate.

### BRIEF DESCRIPTION OF THE DRAWINGS

In order that the invention may be more fully understood and put into practice, a preferred embodiment thereof will now be described with reference to the accompanying drawings, in which:

FIG. 1 is a perspective view of a partially assembled machine;

FIG. 2 is a front elevation of the rotor of the machine;

FIG. 3 is a front elevation of a magnet of the rotor;

FIG. 4 is a cross-sectional front elevation of the tank of the machine;

FIG. 5 is a cross-sectional end elevation of the tank depicting one of the end side walls thereof;

FIG. 6 is a cross-sectional end elevation of a magnet of the rotor supported by a pair of support bearings that are secured to a bearing carrier;

FIG. 7 is a cross-sectional plan elevation of the rotor supported by two opposing pairs of support bearings;

FIG. 8 is a front elevation of an alternative magnet for the rotor; and

FIG. 9 is a cross-sectional elevation of the alternative magnet.

### BEST MODES(S) FOR CARRYING OUT THE INVENTION

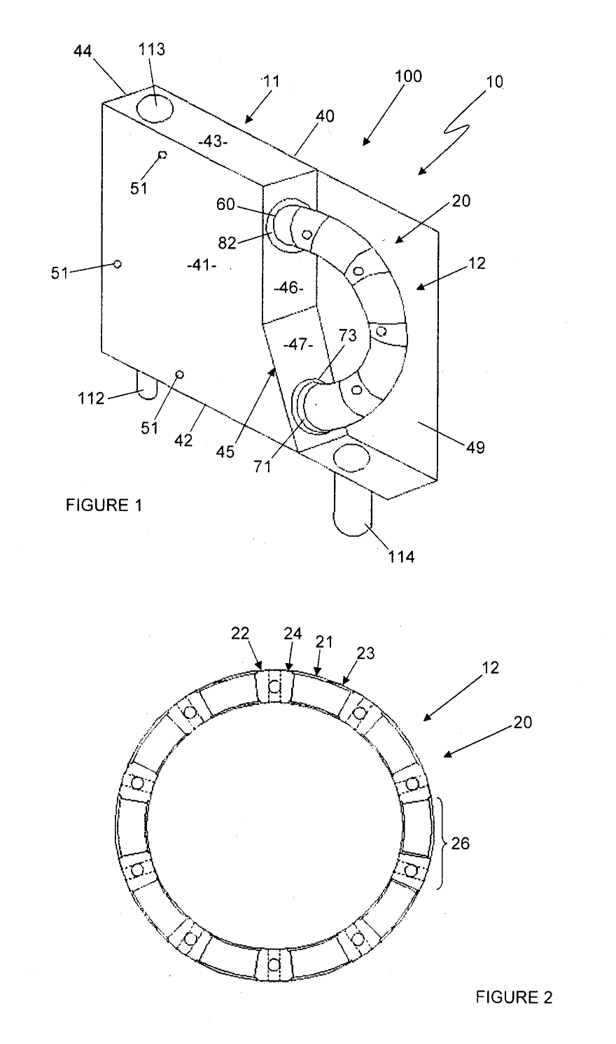

Referring to FIG. 1 there is shown a machine 10 which comprises a tank 11 for holding a liquid, and a rotor 12 which is located in the tank 11 and which is mounted such that the rotor 12 is able to rotate relative to the tank 11.

Referring to FIG. 2, the rotor 12 comprises a toroid wheel 20 that includes a plurality of positively buoyant first elements 21 and a plurality of negatively buoyant second elements 22. Each first element 21 comprises a hollow tube 23, and each second element 22 comprises a magnet 24. The tubes 23 and magnets 24 have circular cross-sectional profiles.

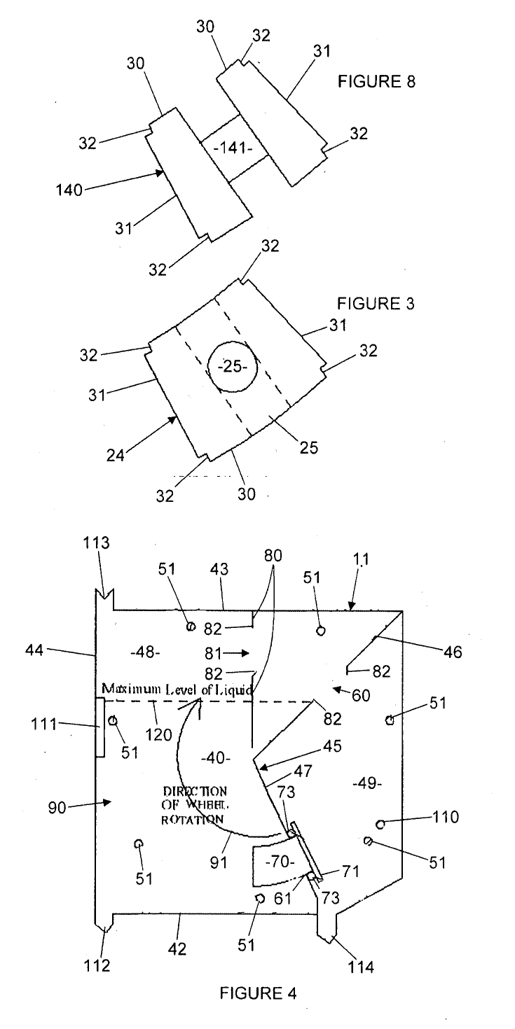

As shown in FIG. 3, each magnet 24 has a pair of holes 25 drilled through it which are at right angles/ninety degrees to each other. One of the holes 25 is drilled so that it is parallel to a central rotational axis of the toroid wheel 20. It is this hole 25 whose circular outline is visible in FIG. 3. The other hole 25 is drilled so that it extends through the magnet 24 radially with respect to the axis of rotation of the toroid wheel 20. The radially extending hole 25 is depicted in phantom in FIG. 3.

Referring again to FIG. 2, the toroid wheel 20 is divided into a plurality of sections 26 each comprising a single tube 23 and a single magnet 24. The toroid wheel 20 comprises ten such sections 26, so that there is a total of ten tubes 23 and a total of 10 magnets 24.

Referring once more to FIG. 3, each magnet 24 includes a main portion 30, and a respective end portion 31 extending from each end of the main portion 30. The main portion 30 and each end portion 31 have a circular cross-sectional profile. The diameter of each end portion 31 is less than the diameter of the main portion 30, and the end portions 31 are concentric with the main portion 30 so that a respective circular land 32 provided by the main portion 30 extends around the circumference of each end portion 31.

Each end portion 31 of each magnet 24 is inserted into an end of a respective one of the tubes 23 until the tube ends abut against the lands 32 of the magnet 24. One of the tubes 23 that one of the end portions 31 of the magnet is inserted into belongs to the same section 26 as the magnet 24, while the other tube 24 that the other end portion 31 of the magnet 24 is inserted into belongs to an adjacent section 26.

The joins between the magnets 24 and the tubes 23 are sealed with a suitable sealant to prevent liquid from entering the tubes 23 through the joins. In this way, the first elements 21 which comprise the tubes 23 are provided with their positive buoyancy.

The negative buoyancy of the second elements 22 is provided by the magnets 24 which, as mentioned above, the second elements 22 are comprised of.

Tank 11 comprises a rear side wall 40, a front side wall 41, a bottom wall 42, a top wall 43, an end side wall 44, and an end side wall 45. End side wall 45 includes an upper section 46 and a lower section 47. The rear side wall 40, front side wall 41, bottom wall 42, top wall 43, end side wall 44, and end side wall 45 define a hollow liquid chamber 48 for holding a liquid.

As can be seen in FIG. 1, both the rear side wall 40 and the bottom wall 42 extend past the end side wall 45. Side walls 40, 45 partly define a hollow air chamber 49 for holding air which is (normally) at atmospheric pressure.

Seven bearing carriers 50 are secured to the tank 11 by clamping or otherwise securing them to one or more of the side walls 40, 41. For example, a carrier 50 may be secured to both of the walls 40, 41 by inserting a bolt (not depicted) into a hole 51 in one of the walls 40, 41 and then through a hole 52 which extends through a body 53 of the carrier 50 before then passing through another hole 51 in the other one of the walls 40, 41 so that a threaded shaft of the bolt protrudes from that wall. A nut may then be wound on to the protruding portion of the threaded shaft so as to prevent the bolt from being withdrawn from the holes 51, 52.

The location of each carrier 50 can be seen from the location of the holes 51 in the rear and front side walls 40, 41 of the tank 11 as shown in FIGS. 1 and 4. It can be seen from the location of the holes 51 that some of the carriers 50 are located inside the chamber 48, and that some of the carriers 50 are located outside the chamber 48.

The body 53 of each carrier 50 includes a pair of inclined surfaces 54. A respective bearing 55 is secured to each surface 54 so that the bearings 55 are able to rotate relative to the carrier 50 and so that the bearings 55 are positioned at right angles/ninety degrees relative to each other. Since there are seven carriers 50, and since each carrier 50 has two bearings 55 secured to it, there are consequently seven pairs of/fourteen bearings 55.

The carriers 50 are positioned so that the bearings 55 support the outer perimeter of the toroid wheel 20 as depicted in FIGS. 6 and 7. The bearing carriers 50 are positioned to permit the toroid wheel 20 to rotate freely with little or no resistance or free play, either radially or laterally.

Each bearing 55 has an outer race 56 which is coated with rubber so as to provide the outer race 56 with a larger surface area to support the toroid wheel 20.

The minimum number of pairs of support bearings 55 would be three because the wheel 20 would need at least three continuous support points to ensure satisfactory support.

As can best be seen in FIG. 1, the toroid wheel 20 passes through a hole 60 in the upper section 46 of the end side wall 45, and through a hole 61 in the lower section 47 of the end side wall 45 so that a portion of the wheel 20 is located in the liquid chamber 48, and so that another portion of the wheel 20 is located outside of the chamber 48 but inside the air chamber 49.

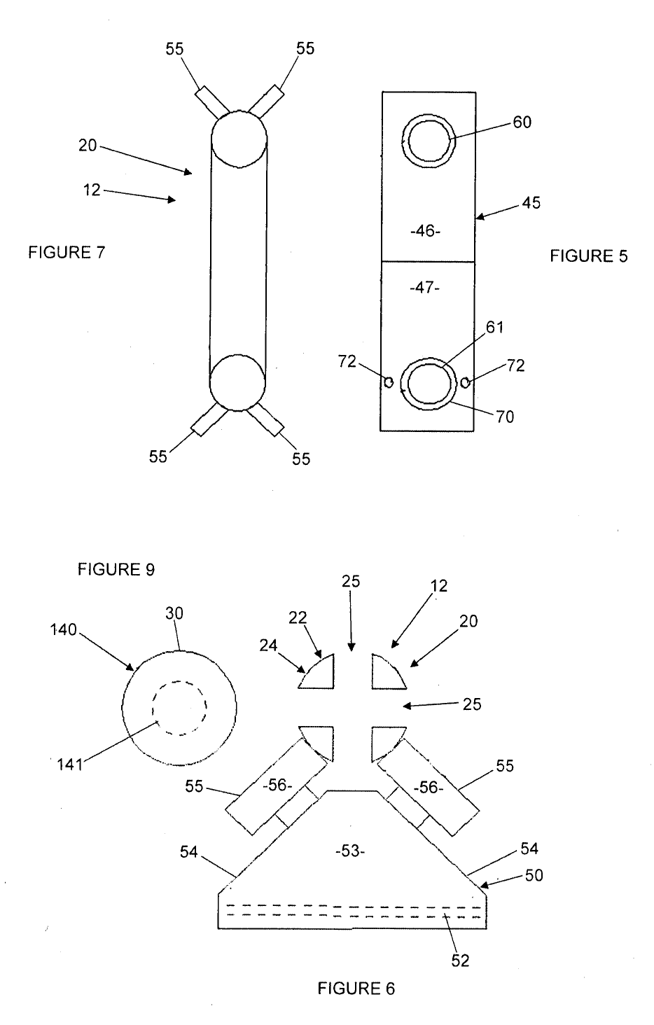

A hollow sealing sleeve or tube 70 extends into the liquid chamber 48 through the hole 61. One end of the tube 70 includes a flange 71 which is secured to the lower section 47 of the end side wall 45 by a pair of bolts 72 (see FIG. 5) so that a sealing O-ring 73 which is located between the flange 71 and the end side wall 45 is slightly compressed. The compressed O-ring 73 serves to prevent liquid from leaking from the chamber 48 from between the tube 70 and the end side wall 45.

The toroid wheel 20 extends through the sealing sleeve 70 which is machined or otherwise shaped so as to be in close contact with the surface of the wheel 20 and prevent or at least inhibit liquid from leaking out of the liquid chamber 48 from between the wheel 20 and the sleeve 70. The sleeve 70 is long enough so that it is able to sufficiently cover each magnet 24 as it passes through the sleeve 70 to prevent or at least inhibit liquid in the chamber 48 from leaking out of the chamber through the holes 25 in the magnet 24.

A baffle plate 80 for assisting in removing excess liquid from the toroid wheel 20 as it rotates out of the liquid chamber 48 through the hole 60 is fitted inside the liquid chamber 48. The baffle plate 80 includes a hole 81 through which the toroid wheel 20 passes.

Wiper rings 82 which extend around the perimeter of the holes 60, 83 are fitted to the upper section 46 of the end side wall 45 and to the baffle plate 80 so that they are also able to assist in removing excess liquid from the toroid wheel 20 as it rotates out of the liquid chamber 48 through the hole 60.

The first elements 21 comprising the tubes 23, and the second elements 22 comprising the magnets 24 are arranged so that when the rotor 12 comprising the toroid wheel 20 is immersed in an upright position in a liquid 90 of a liquid bath which is contained in the liquid chamber 48, the positive buoyancy of the first elements 21 and the negative buoyancy of the second elements 22 are able to cause the rotor 12 to rotate relative to the tank 11. The positive buoyancy of the first elements 21 comprising the sealed tubes 23 which are immersed in the liquid 90 causes those elements 21 to rise in the liquid 90, while the negative buoyancy of the second elements 22 which is due to the weight of the magnets 24 causes the magnets 24 which are located in the open air/air chamber 49 outside of the liquid chamber 48 to fall so that the rotor 12 rotates in the clockwise direction indicated by the arrow 91 in FIG. 4.

It is envisaged that the rotor 12 can rotate continuously in the manner explained above with little if any external assistance, in which case the machine 10 would comprise a perpetual or near perpetual motion machine.

In order for the machine 10 to serve a useful purpose, it may be configured as an electricity generator 100 by winding one or more coils (not depicted) around the rotor 12 and securing the coils so that they are able to remain substantially stationary relative to the rotor 12 as the rotor 12 rotates. Each of the magnets 24 function as a magnetic field source of the generator 100, and each coil functions as an armature of the generator 100. The armatures are positioned relative to the rotor 12 so that as the rotor 12 rotates, the magnetic fields produced by the magnets 24 interact with the armatures so that a voltage is caused to be generated across the armature. The generated voltage would be an alternating/AC voltage so that the generator 100 would actually be an alternator. The generator 100 can be used to supply an electric current that may be utilised as desired.

The rotational speed of the rotor 12 can be controlled by suitably varying the level of the liquid 90 in the liquid chamber 48. The higher the level of the liquid 90 in the liquid chamber 48, the faster the rotational speed of the rotor, and vice versa. Therefore, to increase the speed of rotation of the rotor 12, the level of the liquid 90 in the chamber 48 relative to the rotor 12 is increased, and, to decrease the speed of rotation of the rotor 12, the level of the liquid 90 in the chamber relative to the rotor 12 is decreased.

A speed sensor 110 is used to monitor the rotational speed of the rotor 12. If the rotational speed of the rotor 12 is too high/fast compared to a desired rotational speed, an electronic circuit (not depicted) and a fluid level sensing device 111 function to open a drainage/release valve 112 so that some of the liquid 90 is drained from the liquid chamber 48 through the valve 112. Draining the liquid 90 from the chamber 48 lowers the level of the liquid 90 in the chamber 48 which reduces the rotational speed of the rotor 12.

If the rotational speed of the rotor 12 is too low/slow compared to a desired rotational speed, the aforementioned electronic circuit and the fluid level sensing device 111 function to open a refill valve 113 so that some liquid 90 flows through the valve 113 and into the liquid chamber 48. Introducing liquid 90 in to the chamber 48 raises the level of the liquid 90 in the chamber 48 which increases the rotational speed of the rotor 12.

An overflow valve 114 can be opened if too much liquid 90 should leak past the wiper rings 82 and into the air chamber 49. Opening the valve 114 allows the leaked liquid 90 to drain from the air chamber 49.

As shown in FIG. 4, the chamber 48 can be filled with liquid 90 up to a maximum level 120.

The liquid 90 may be of any suitable type which will allow the buoyant first elements 21 of the rotor 12 to float. For example, the liquid 90 could be water, mercury or, if electrical insulation is required, transformer oil.

Rather than the toroid wheel 20 including magnets 24 of the type depicted in FIGS. 1, 2, 3, and 6, it may include magnets 140 depicted in FIGS. 8 and 9. Magnet 140 does not have drilled holes 25 like the magnet 24. Instead, it has two main portions 30 that are joined together by a waisted section 141.

If the toroid wheel 20 includes magnets 140 rather than magnets 24, the number of segments/sections 26 of the toroid wheel 20 is chosen on purpose so as not to equal the number of pairs of support bearings 55. This is so that never more than one pair of support bearings 55 is adjacent to a magnet 140 at any one time.

Also, if the toroid wheel 20 includes magnets 140 rather than magnets 24, the minimum number of pairs of support bearings 55 that the wheel 20 would need to have is five because the wheel 20 would need at least five continuous support points to ensure satisfactory support. If there were any less than this such as only four pairs of support bearings 55 which are set or positioned at ninety degrees to each other/evenly spaced about the perimeter of the wheel 20, the wheel 20 could move off centre when one magnet 140 becomes aligned with a pair of support bearings 55. This is due to the gap which would be present between the support bearings 55 and the waisted section 141 of the magnet 140 that is aligned with those support bearings 55.

The rotor 12 is described as comprising a toroid wheel 20. The toroid wheel 20 is suggested as being the best option for the rotor 12 because it is easier to form a seal around it using conventional circular oil seal rings such as the wiper rings 82.

Instead of the rotor 12 comprising a toroid wheel 20 which is supported about its periphery by a plurality of support bearings 55, the rotor 12 could comprise a traditional spoked wheel (not depicted) that uses a suitably mounted central axle to support it rather than a plurality of support bearings 55 about its periphery. This is provided that the segments/sections 26 which would need to be attached to the wheel could be satisfactorily sealed against leakage of the liquid 90 from the chamber 48.

The number of segments/sections 26 (and, therefore the number of positively buoyant first elements 21 and negatively buoyant second elements 22) that the rotor 12 has is not critical. However, the more sections 26 there are, the smoother the rotation of the rotor 12, so it is preferred to have as many segments 26 as possible (and, therefore, as many positively buoyant first elements 21 and negatively buoyant second elements 22 as possible).

The electricity generator 100 could be placed in a vehicle to provide electrical power to propel the vehicle. It could alternatively be placed in a remote location such as a remote African village where it could be used to generate electricity for the community. Ideally, all that would be necessary is to transport the generator 100 to the location where electricity is required and to fill the chamber 48 with water.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

For example, variations to the sections 26 of the toroid wheel 12, the size of the magnets 24, the type of the liquid 90, the number and/or position of the support bearings 56, or the sealing arrangements may be made without departing from the spirit of the invention.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “substantially” or “about” will be understood to not be limited to the value for the range qualified by the terms.

It will be clearly understood that, if a prior art publication is referred to herein, that reference does not constitute an admission that the publication forms part of the common general knowledge in the art in Australia or in any other country.

1. A machine comprising a tank defining a liquid chamber for holding a liquid, and a rotor which is located in the liquid chamber and which is mounted such that the rotor is able to rotate relative to the tank, the rotor comprising a plurality of positively buoyant first elements and a plurality of negatively buoyant second elements, wherein the liquid chamber is able to hold the liquid so that the rotor is immersed in the liquid and the first and second elements are arranged so that the positive buoyancy of the first elements and the negative buoyancy of the second elements are able to cause the rotor to rotate.

2. The machine according to claim 1, wherein the rotor extends through a side wall of the tank so that a portion of the rotor is located inside the liquid chamber and so that another portion of the rotor is located outside the liquid chamber.

3. The machine according to claim 2, wherein the tank also defines an air chamber for holding air, and the portion of the rotor which is located outside the liquid chamber is located in the air chamber.

4. The machine according to claim 1, wherein the rotor comprises a toroid wheel formed by securing together the positively buoyant first elements and negatively buoyant second elements, and the tank also comprises a plurality of bearings for supporting a perimeter of the toroid wheel.

5. The machine according to claim 1, wherein the positively buoyant first elements comprise tubes.

6. The machine according to claim 1, wherein the negatively buoyant second elements comprise magnets.

7. The machine according to claim 6, wherein a plurality of holes extend through each magnet.

8. The machine according to claim 6, wherein each magnet includes a waisted section.

9. The machine according to claim 1, wherein the tank also comprises a release valve for draining the liquid from the liquid chamber, and a refill valve for refilling the tank with liquid, and the machine also comprises a speed sensor for monitoring the rotational speed of the rotor, an electronic circuit, and a fluid level sensing device for sensing the level of the liquid in the tank, wherein the electronic circuit and the fluid level sensing device are operable to cause the release valve to open to drain some of the liquid from the liquid chamber if the rotational speed of the rotor is faster than a desired rotational speed, and are operable to cause the refill valve to open to allow some liquid to flow into the liquid chamber if the rotational speed of the rotor is slower than a desired rotational speed.

10. The machine according to claim 1, wherein the tank also comprises an overflow valve for draining liquid from the air chamber that has leaked into that chamber from the liquid chamber.

11. The machine according to claim 4, wherein the machine also comprises an armature wound around the toroid wheel so that rotation of the rotor is able to cause a voltage to be generated across the armature.

12. A method of rotating the rotor of the machine according to claim 1, the method comprising the steps of:
filling the liquid chamber of the tank with a liquid so that the rotor is immersed in the liquid; and
allowing the positive buoyancy of the first elements and the negative buoyancy of the second elements to cause the rotor to rotate.

13. A method of controlling the speed of rotation of the rotor of the machine according to claim 1 the method comprising the steps of:
lowering the height of the liquid in the liquid chamber relative to the rotor so as to decrease the speed of rotation of the rotor; and
raising the height of the liquid in the liquid chamber relative to the rotor so as to increase the speed of rotation of the rotor.

14. An electricity generator comprising the machine according to claim 1, a magnetic field source, and an armature, the rotor of the machine including one of the magnetic field source and the armature, and the other of the magnetic field source and the armature being positioned relative to the rotor such that rotation of the rotor is able cause a voltage to be generated across the armature.

15.-20. (canceled)
